(19) United States
(12) Patent Application Publication
(10) Pub. No.: US 2005/0129287 A1
(43) Pub. Date: Jun. 16, 2005

(54) Image processing method

(75) Inventor: Jun Enomoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/963,775

(22) Filed: Oct. 14, 2004

(30) Foreign Application Priority Data
Oct. 14, 2003 (JP) 2003-353889

(51) Int. Cl. G06K 9/00

(52) U.S. Cl. 382/117; 382/167

(57) ABSTRACT

The image processing method performs predetermined processing on first image data of an first image obtained by optical photographing to obtain second image data for outputting. The method detects each pupil region, in which a red eye phenomenon occurs, in the first image based on the first image data, performs red eye correction on the detected pupil region through image processing based on the first image data and generates an appropriate catch light in the detected pupil region having undergone the red eye correction to obtain a second image having the appropriate catch light to a photographed scene of the first image.

This application claims priority on Japanese patent application No.2003-353889, the entire contents of which are hereby incorporated by reference. In addition, the entire contents of literatures cited in this specification are incorporated by reference.

### BACKGROUND OF THE INVENTION

The present invention relates to a technical field of digital image processing applied to a digital photoprinter or the like that photoelectrically reads images on a film and obtains prints (photographs) in which the images have been reproduced, In particular, the present invention relates to an image processing method for appropriately correcting a red eye phenomenon in a living body image, such as a human image or an animal image, ascribable to strobe photographing and obtaining a finished image of the living body image in which appropriate catch light exists.

Heretofore, images photographed on photographic films such as negative films and reversal films (hereinafter simply referred to as the “films”) have been commonly printed on photosensitive materials (printing paper) through so-called direct exposure (analog exposure).where the images on the films are projected onto the photosensitive materials and the photosensitive materials are area-exposed.

A printer that relies upon digital exposure has recently been commercialized. Called a “digital photoprinter”, the apparatus operates in the following manner: the image recorded on a film is read photoelectrically; the image is then converted to a digital signal and subjected to various image processing to produce recording image data; a photosensitive material is exposed by scanning with recording light modulated in accordance with the image data, whereby an image (latent image) is recorded; the necessary processing is done to produce a (finished) print.

In such a digital photoprinter, it is possible to convert images into digital image data and determine exposure conditions at the time of printing through image data processing, which makes it possible to obtain high-quality prints, which have been unobtainable with the conventional direct exposure, by suitably performing various corrections such as a correction of washed-out highlights and dull shadows of an image ascribable to backlight, strobe photographing, or the like, sharpness (sharpening) processing, a correction of color failure or density failure, a correction of underexposure or overexposure, and a correction of marginal luminosity. In addition, it is also possible to synthesize multiple images with each other, divide an image into segments, synthesize letters with an image, and perform other image editing through image data processing, which makes it possible to output prints where images have been freely edited/processed in accordance with the use of the prints. Also, with the digital photoprinter, aside from outputting of images as prints (photographs), it is also possible to supply image data of the images to a computer or the like or store the image data in a recording medium such as a floppy (registered trademark) disk. Consequently, it becomes possible to use the image data for various purposes other than photograph outputting.

To do so, the digital photoprinter basically includes a scanner (image reading apparatus) that photoelectrically reads images recorded on a film, an image processing apparatus that determines exposure conditions for image recording by processing the read images, and a printer (image recording apparatus) that creates prints by scan-exposing a photosensitive material in accordance with the determined exposure conditions and performing development processing on the exposed photosensitive material.

In the scanner, projection light bearing the images photographed on the film is obtained by making reading light emitted from a light source incident on the film, the photographed images are read by imaging the projection light on an image sensor, such as a CCD sensor, using an imaging lens and photoelectrically converting the projection light with the image sensor, various kinds of image processing are performed on the read images as necessary, and resultant images are sent to the image processing apparatus as image data (image data signal) of the film. The image processing apparatus sets image processing conditions from the image data sent from the scanner, performs image processing corresponding to the set conditions on the image data, and sends resultant image data to the printer as output image data for image recording. In the printer, when this printer is an apparatus utilizing light beam scan-exposure, for instance, a light beam is modulated in accordance with the image data sent from the image processing apparatus and the modulated light beam is deflected in a main scanning direction while transporting a photosensitive material in an auxiliary scanning direction orthogonal to the main scanning direction. In this manner, the photosensitive material is exposed (printed) by the light beam bearing the images and latent images are formed. Next, the exposed photosensitive material is subjected to development processing and the like appropriate to the photosensitive material, thereby creating prints (photographs) where the images photographed on the film have been reproduced.

Incidentally, the most important factor that determines the image quality of a print of an image, such as a portrait, that contains a human subject is how fine the human subject is finished. In particular, a red eye phenomenon, in which eye portions are colored in red due to the influence of strobe light emission and the like at the time of photographing, constitutes a serious problem.

Also, catch light that is light taken in the eye portions of a human subject has an effect that the photographed human subject gives a lively impression. Therefore, it is preferred that such catch light be clearly taken in the eye portions of a human image.

It should be noted here that the red eye phenomenon and the catch light do not concern only an image, in which a human subject has been photographed, and similarly applies to a living body image including an animal image where a dog, a cat, or the like-has been photographed.

Incidentally, the red eye phenomenon is a phenomenon that occurs because of strobe light that passes through pupils, is reflected by eyegrounds where capillary vessels of retinas exist, and returns to the lens of a camera as light colored in red.

Also, the catch light is a phenomenon that occurs because illumination light in a scene is reflected by the surfaces of eyes and the reflected light returns to the lens.

Image processing apparatuses that output human images as more favorable images by processing human images in which such a red eye phenomenon occurs,-and human images in which catch light taken in pupil regions is insufficient are described in JP 11-308474 A and JP 2000-76427 A, for instance.

In the image processing apparatus described in JP 11-308474 A, it is possible to carry out each of red eye correction processing and catch light processing with respect to human images. With a catch light correction method disclosed in JP 11-308474 A, however, the contrasts of catch light regions that originally exist in the pupil regions of images and are relatively high in lightness as compared with their peripheral regions are merely increased for the sake of catch light emphasizing. Accordingly, with the image processing apparatus described in JP 11-308474 A, when such catch light regions having high lightness as compared with their peripheral regions do not originally exist in the pupil regions in images, it is impossible to generate catch light. Therefore, there is a problem that in spite of a fact that images with catch light are desired, images having no catch light are produced and an unnatural feeling still remains in the images.

Also, in the image processing apparatus described in JP 2000-76427 A, catch light patterns that are patterns having relatively high lightness as compared with their peripheral regions are added to images having undergone red eye correction processing. In JP 2000-76427 A, however, such catch light patterns are merely added at the maximum lightness positions of red eye regions before correction. Also, the lightness of the catch light patterns is adjusted in accordance with the lightness of eyes having undergone the red eye correction. With this technique, it is possible to correct red eyes and to emphasize or add catch light in accordance with a photographing scene (in accordance with which kind of illumination light (fluorescent light, tungsten light, or the like) existed at the time of strobe photographing, for instance), although there is a problem that the emphasized or added catch light lacks naturality and, when a high image quality is desired, an unnatural feeling is still felt in the images.

### SUMMARY OF THE INVENTION

The present invention has been made in order to solve the problems of the conventional techniques described above and has an object to provide an image processing method with which it is possible to correct red eyes occurring in the pupil regions of a living body image, such as a human image or an animal image, and it is also possible to correct an image in which catch light in pupil regions is insufficient to a favorable image having catch light appropriate to a photographing scene.

In order to attain the object described above, the present invention provides an image processing method of performing predetermined processing on first image data of an first image obtained by optical photographing to obtain second image data for outputting, comprising: detecting each pupil region, in which a red eye phenomenon occurs, in the first image based on the first image data; performing red eye correction on detected pupil region through image processing based on the first image data; and generating an appropriate catch light in the detected pupil region having undergone the red eye correction to obtain a second image having the appropriate catch light to a photographed scene of the first image.

Preferably, the generating step of the appropriate catch light comprises a step of adding a catch light pattern to the detected pupil region having undergone the red eye correction.

Preferably, the adding step of the catch light pattern comprises a step of changing at least one of a shape, a color tint and a position of a catch light pattern to be added in accordance with the photographed scene.

Preferably, the changing step comprises a step of selecting one from among a plurality of catch light patterns, which have been prepared in advance and are different from each other in at least one of the shape, the color tint, and the position, in accordance with the photographed scene.

Preferably, the color tint of the catch light pattern is changed in accordance with one of a color tint of a photographing light source of the first image and a kind of a light source illuminating a subject in the first image.

Preferably, the generating step of the appropriate catch light comprises a step of detecting a state of a catch light in the detected pupil region and, when the detected catch light is insufficient, a step of emphasizing the detected catch light existing in the detected pupil region having undergone the red eye correction.

Preferably, the detecting step of the state comprises a step of investigating presence and a degree of a catch light in the pupil region or absence of the catch light therein, in which the red eye phenomenon occurs, before the red eye correction is performed.

Preferably, the detection of the state comprises a step of investigating presence and a degree of a catch light in the detected pupil region or absence of the catch light therein, in which the red eye phenomenon occurs, after the red eye correction is performed.

Preferably, the emphasizing step of the detected catch light comprises a step of changing at least one of a shape, a color tint, and a position of the detected catch light to be emphasized in accordance with the photographed scene.

Preferably, the changing step comprises a step of selecting one from among a plurality of catch lights, which have been prepared in advance and are different from each other in at least one of the shape, the color tint and the position, in accordance with the photographed scene.

And, preferably, the color tint of the detected catch light is changed in accordance with one of a color tint of a photographing light source of the first image and a kind of a light source illuminating a subject in the first image.

According to the present invention, a living body image such as a human image or an animal image in which a red eye phenomenon occurs and catch light is not sufficient or present can be made more preferable by correcting the red eye phenomenon and giving catch light having natural impression in accordance with a photographing scene.

Further, according to the present invention, the shape, color tint, and position of a catch light pattern are changed in accordance with a photographing scene, for instance, depending on the presence of environmental light, fluorescent light or tungsten light at the time of strobe photographing to optimize catch light, whereby a high-quality image having no unnatural feeling can be obtained in which red eyes are appropriately corrected and the catch light is made appropriate and natural, thus giving a subject human or animal a lively impression.

### BRIEF DESCRIPTION OF THE DRAWINGS

In the accompanying drawings:

FIG. 1 is a block diagram of a digital photoprinter utilizing an embodiment of the image processing method according to the present invention;

FIG. 2A is a conceptual diagram of a scanner fitted to the digital photoprinter shown in FIG. 1;

FIG. 2B is a conceptual diagram of an image sensor arranged in the digital photoprinter shown in FIG. 1;

FIG. 3 is a block diagram of an image processing apparatus of the digital photoprinter shown in FIG. 1; and

FIGS. 4A to 4D are schematic diagrams showing the shapes of catch light patterns used in the embodiment of the image processing method according to the present invention.

### DETAILED DESCRIPTION OF THE PREFERRED EMBODIMENTS

The image processing method according to the present invention will now be described in detail based on a preferred embodiment with reference to the accompanying drawings.

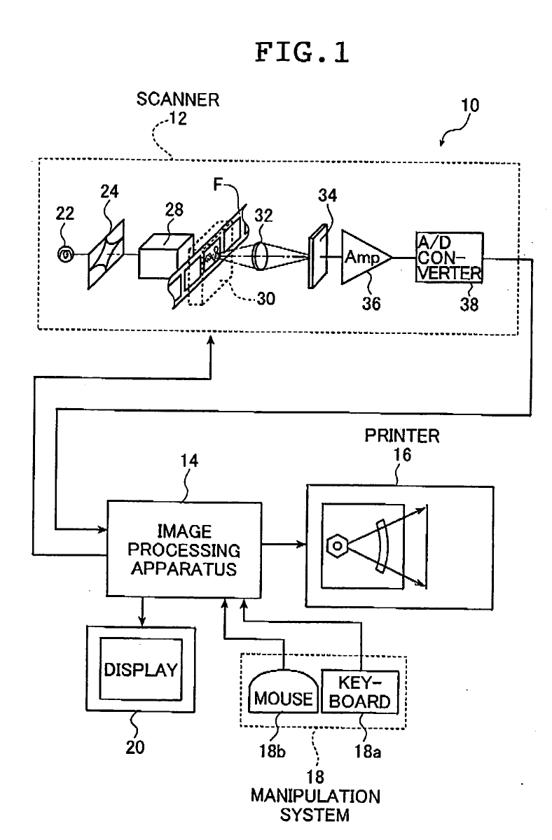

FIG. 1 is a block diagram of a digital photoprinter that utilizes an embodiment of the image processing method according to the present invention.

As shown in FIG. 1, a digital photoprinter (hereinafter simply referred to as the “photoprinter”) 10 basically includes a scanner (image reading apparatus) 12 that photoelectrically reads images photographed on a film F, an image processing apparatus 14 that processes image data (image information) of the read images to thereby obtain image data for outputting and performs overall control and the like of the photoprinter 10, and a printer 16 that exposes a photosensitive material (printing paper) imagewise with a light beam modulated in accordance with the image data outputted from the image processing apparatus 14, develops the exposed photosensitive material, and outputs the developed photosensitive material as (finished) prints.

Also, connected to the image processing apparatus 14 is a manipulation system 18 including a keyboard 18a and a mouse 18b that are used by an operator to input and set various conditions, select and designate specific processing, designate color/density correction and the like, and perform other manipulations. In addition, a display 20 that displays the images read by the scanner 12, various designations for manipulations, a condition setting/registration screen, and the like is also connected to the image processing apparatus 14.

The scanner 12 is an apparatus that photoelectrically reads the images photographed on the film F and the like and includes a light source 22, a variable diaphragm 24, a diffusion box 28 that uniformizes reading light to be incident on the film F in the plane direction of the film F, an imaging lens unit 32, an image sensor 34 having a line CCD sensor for image reading in each of R (red), G (green), and B (blue), an amplifier (Amp) 36, and an A/D (analog/digital) converter 38.

Also, in the photoprinter 10, various dedicated carriers are prepared which are detachably attached to the main body of the scanner 12 in accordance with the kind and size of the film F (Advanced Photo System (APS) film or 135-size negative (or reversal) film, for instance), the form of the film F (strip or slide, for instance), and the like. By replacing one carrier by another, it becomes possible to cope with various kinds of films. Images that have been photographed on the film F and are to be printed (or their frames) are transported to a predetermined reading position by a carrier corresponding to the film F.

In the scanner 12 having the construction described above, at the time of reading of the images photographed on the film F, the reading light emitted from the light source 22 and adjusted in light amount by the variable diaphragm 24 strikes the film F positioned at the predetermined reading position by means of the carrier and passes through the film F. In this manner, the projection light bearing the images photographed on the film F is obtained.

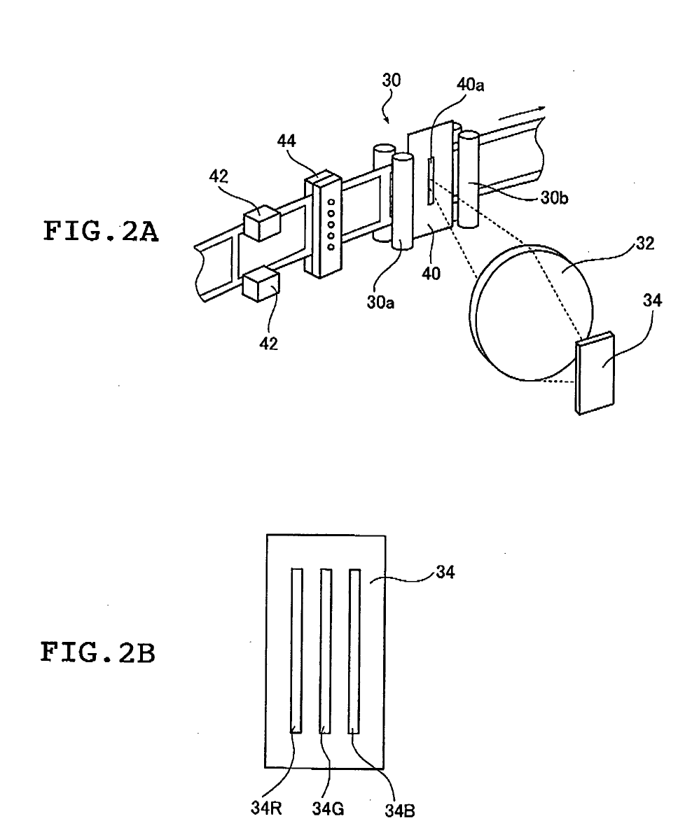

As shown in FIG. 2A, the carrier 30 includes transport roller pairs 30a and 30b arranged so that the predetermined reading position is located therebetween, and a mask 40 having a slit 40a that is positioned so as to correspond to the reading position and regulates the projection light from the film F in a predetermined slit shape. The slit 40a extends in the same direction (main scanning direction) as the direction in which the line CCD sensor extends and the transport roller pairs 30a and 30b transport the film F to the reading position by setting the lengthwise direction of the film F as an auxiliary scanning direction orthogonal to the main scanning direction.

The film F is transported in the auxiliary scanning direction to the reading position by the carrier 30 and is struck by the reading light at the reading position. As a result of this operation, the film F is two-dimensionally slit-scanned by the slit 40a extending in the main scanning direction and the image in each frame photographed on the film F is read.

A magnetic recording medium is formed in each APS film and magnetic heads 42 that perform recording/reading of information into/from this magnetic recording medium are arranged in the carrier 30 supporting the APS film (cartridge). The information recorded in the magnetic recording medium of the film is read by the magnetic heads 42 and is sent to the image processing apparatus 14 and the like. Also, information from the image processing apparatus 14 and the like is transferred to the carrier 30 and is recorded in the magnetic recording medium of the film F by the magnetic heads 42.

Also, a code reader 44 that reads barcodes (such as a DX code, an extended DX code, and an FNS code) optically recorded in the film F and various kinds of information also optically recorded in the film is arranged in the carrier 30 and the barcodes and information read by the code reader 44 is sent to the image processing apparatus 14 and the like.

As shown in FIG. 2B the image sensor 34 is a so-called 3-line color CCD sensor including a line CCD sensor 34R for reading R images, a line CCD sensor 34G for reading G images, and a line CCD sensor 34B for reading B images, and extends in the main scanning direction. The projection light from the film F is decomposed into the three primary colors that are R. G, and B and is photoelectrically read by the image sensor 34.

An output signal from the image sensor 34 is amplified by the amplifier 36, is converted into a digital signal by the A/D converter 38, and is sent to the image processing apparatus 14.

In the scanner 12, the images photographed on the film F are read through two kinds of image reading that are prescan for reading at a low resolution and fine scan for obtaining image data of an output image.

The prescan is performed under a prescan reading condition set so as to read every image on the film (reading target of the scanner 12) as an input image without causing saturation of the image sensor 34. On the other hand, the fine scan is performed under a fine scan reading condition set separately for each frame from prescan data so that the image sensor 34 is saturated at a density that is somewhat lower than the minimum density of the image (frame). Accordingly, even if prescan output signal and fine scan output signal are generated from the same image, they are different from each other in resolution and output level.

It should be noted here that in the present invention, the scanner is not limited to such a scanner based on the slit-scanning and may be a scanner that utilizes area-exposure where the whole of the image in one frame is read at a time. In this case, for instance, an area CCD sensor is used in place of the line CCD sensor, a means for inserting respective color filters for R, G, and B is provided between the light source and the film F, the images photographed on the film are decomposed into the three primary colors by sequentially inserting the respective color filters, and images in the three primary colors are sequentially read with the area CCD sensor.

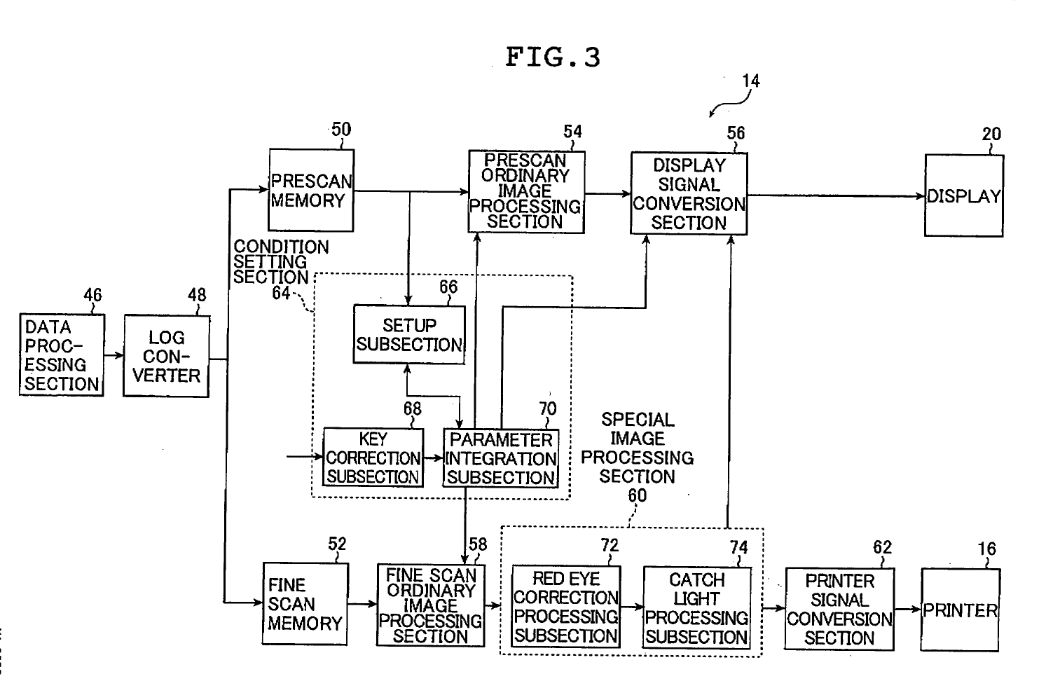

FIG. 3 is a block diagram of the image processing apparatus 14. As shown in FIG. 3, the image processing apparatus 14 (hereinafter simply referred to as the “processing apparatus 14”) includes a data processing section 46, a Log converter 48, a prescan (frame) memory 50, a fine scan (frame) memory 52, a prescan ordinary image processing section (hereinafter simply referred to as the “prescan processing section”) 54, a display signal conversion section 56, a fine scan ordinary image processing section (hereinafter simply referred to as the “fine scan processing section”) 58, a special image processing section 60, a printer signal conversion section 62, and a condition setting section 64.

It should be noted here that FIG. 3 mainly shows sites relating to image processing. Therefore, in the image processing apparatus 14, in addition to the components described above, a CPU that performs overall control and management of the photoprinter 10 including the processing apparatus 14, a memory storing information necessary for operations of the photoprinter 10 and the like, a means for determining the f-number of the variable diaphragm 24 and the accumulation time period of the CCD sensor 34, and the like are arranged. Also, the manipulation system 18 and the display 20 are connected to each site through the CPU and the like (CPU bus).

Respective output signals for R. G and B outputted from the scanner 12 are first subjected to predetermined processing, such as DC offset correction, dark current correction, and shading correction, in the data processing section 46 and is next converted into digital image data by the Log converter 48. Then, prescan (image) data is stored (saved) in the prescan memory 50 and fine scan (image) data is stored (saved) in the fine scan memory 52.

The prescan data stored in the prescan memory 50 is processed in the prescan processing section 54 and is converted into image data for displaying on the display 20. On the other hand, the fine scan data stored in the fine scan memory 52 is processed in the fine scan processing section 58 and the special image processing section 60 and is converted into image data for outputting by the printer 16.

The prescan processing section 54 and the fine scan processing section 58 are each a site at which various image processing (hereinafter referred to as the “ordinary image processing”) other than red eye correction processing is performed on each image (image data) read by the scanner 12 in accordance with a setting made by the condition setting section 64 to be described in detail later. These sections 54 and 58 perform basically the same processing except that the pixel density of image data processed in the section 54 and the pixel density of image data processed in the section 58 are different from each other.

The ordinary image processing performed in the prescan processing section 54 and the fine scan processing section 58 is various known kinds of image processing, examples of which include gray balance adjustment, gradation adjustment, density adjustment, electronic magnification processing, sharpness (sharpening) processing, graininess suppression processing, dodging processing (addition of a dodging effect in a photoprinter of direct exposure type through image data compression where a halftone is maintained), geometric distortion correction, marginal luminosity correction, special finishing such as soft-focus finishing and black-and-white finishing, and the like.

Each of these processing can be performed with a known method. For instance, these processing is performed by combining processing computation (algorithm), processing by an adder or a subtracter, processing based on a LUT (lookup table), matrix (MTX) computation, processing by a filter, and the like with each other as appropriate.

In more detail, for instance, the gray balance adjustment, the density adjustment, and the gradation adjustment are performed with a method using a LUT created in accordance with image characteristic amounts, the chroma adjustment is performed with a method using MTX computation, and the sharpness processing is performed with a method with which an image is separated into frequency components, brightness signals obtained from middle- and high-frequency components are multiplied by sharpness gains (sharpness correction coefficients), and obtained brightness information is added to a low-frequency component.

Image-processed prescan data having undergone the ordinary image processing in the prescan processing section 54 in this manner is sent to the display signal conversion section 56.

The display signal conversion section 56 converts the image data into image data for displaying on the display 20 using a 3D (three-dimensional)-LUT or the like.

On the other hand, image-processed fine scan data having undergone the ordinary image processing in the fine scan processing section 58 is sent to the special image processing section 60.

The special image processing section 60 includes a red eye correction processing subsection 72 and a catch light processing subsection 74. When a red eye phenomenon occurs in an input image, the red eye correction processing subsection 72 performs red eye correction processing where each pupil region in which the red eye phenomenon occurs in the input image is automatically detected and corrected. Also, the catch light processing subsection 74 generates catch light in the pupil region having undergone the red eye correction in the red eye correction processing subsection 72 in accordance with a photographing scene of the input image. For instance, the catch light processing subsection 74 adds catch light appropriate to the photographing scene to the pupil region having undergone the red eye correction in the red-eye-corrected image. Alternatively, the catch light processing subsection 74 detects catch light in the pupil region in the red eye correction target image as necessary and emphasizes the detected catch light in the red-eye-corrected pupil region in accordance with the photographing scene or adds catch light appropriate to the photographing scene to the red-eye-corrected pupil region.

It should be noted here that the special image processing section 60 is also connected to the display signal conversion section 56, thereby making it possible for the operator to confirm on the display 20 the contents of the special image processing such as the red eye correction processing and the catch light generation processing, carried out in the special image processing section 60. In addition, the special image processing section 60 is also connected to the manipulation system 18, thereby allowing the operator to perform the special image processing such as the red eye correction processing and the catch light generation processing, by inputting and designating the contents, conditions, processing positions, and the like of the special image processing using the keyboard 18a and the mouse 18b through a GUI (graphical user interface) while confirming an image displayed on the display 20.

The contents of the special image processing in the special image processing section 60, that is, the contents of the red eye correction processing in the red eye correction processing subsection 72 and the contents of the catch light generation processing in the catch light processing subsection 74 will be described in detail later.

Image-processed fine scan data having undergone the ordinary image processing in the fine scan processing section 58 and optionally the special image processing such as the red eye correction processing and the catch light generation processing in the special image processing section 60 in this manner is sent to the printer signal conversion section 62.

The image is processed in the fine scan image processing section 58 and is optionally subjected to the red eye correction processing and the catch light generation processing in the red eye correction processing subsection 72 and the catch light processing subsection 74 of the special image processing section 60 to obtain image data of the image in which the red-eye-corrected pupil region has catch light generated in accordance with a photographing scene. The obtained data is converted in the printer signal conversion section 62 using a 3D-LUT or the like into image data for image recording by the printer 16, which is then supplied to the printer 16.

Next, the special image processing performed in the special image processing section 60 will be described.

The red eye correction processing performed in the red eye correction processing subsection 72 is performed using a full-automatic red eye correction processing method with which each red eye in an image is automatically detected (red eye detection) through image analysis and is automatically corrected (red eye correction) through image processing. Note that a semi-automatic red eye correction processing method may be used instead with which each fine scan image based on the fine scan data from the special image processing section 60 is displayed on the display 20 through the display signal conversion section 56, one point in one or more eyes or its nearby region in the fine scan image where a red eye phenomenon occurs is designated by the operator, and the red eye is automatically detected at the designated point or with reference to the designated region and is automatically corrected.

Here, a method of detecting each red eye in the red eye correction processing subsection 72 is not specifically limited and it is possible to use various known methods.

For instance, it is possible to use a method with which face extraction is performed and each pupil and/or each red eye are/is detected from the extracted face.

It is possible to perform the face extraction with a known method, examples of which include a face detection method based on edge detection or shape pattern detection and a face detection method based on hue extraction or flesh color extraction. Also, it is possible to use a method with which a candidate region is extracted, this candidate region is divided into small regions, characteristic amounts in each small region are matched against a preset face region pattern, and a face region is extracted based on the accuracy (see JP 2000-137788 A). Further, it is possible to use a method with which face candidate regions are extracted, the accuracy is evaluated from the overlapping degree of each candidate region, and a face region is extracted using the accuracy (see JP 2000-149018 A). Aside from these methods, it is possible to use a method with which a face candidate region is extracted, a trunk candidate region is extracted when the density of the face candidate region has a value corresponding to a predetermined threshold value, the accuracy is evaluated using densities and chroma contrasts in the face and trunk candidate regions, and a face region is extracted based on the accuracy (see JP 2000-148980 A).

Also, it is-possible to detect each red eye from the extracted face region with a known method.

For instance, it is possible to use a method with which pupil detection is performed using edge detection, shape pattern detection, position information, hue information, or the like and red eye detection is performed using hue or the like. Also, it is possible to use a method with which each eye is extracted using edge detection, shape pattern detection, position information, or the like, a low brightness region is extracted from the brightness histogram of image data of the extracted eye, a pupil region is extracted by performing contraction processing on the extracted low brightness region, and red eye detection is performed using hue or the like. Further, it is possible to use a method with which image characteristic amounts z of each pixel are obtained using hue or the like assuming that a face candidate region is on an xy plane, an xyz three-dimensional space is set, the xy plane is divided based on a mountain-like distribution of the z value, and red eye detection is performed for each divided region using shape information, statistical image characteristic amounts, or the like (see JP 2000-76427 A).

Further, a method of correcting each detected red eye is not specifically limited and it is possible to use various known methods.

For instance, it is possible to use a method with which the detected red eye is corrected through color conversion or chroma reduction of the detected red eye or a method with which all other pixels in a detected red eye region are corrected for the chroma and lightness so as to approach the pixel having the minimum lightness (see JP 2000-76427 A).

In this embodiment, it is also possible for the operator to manually perform the red eye correction processing in the special image processing section 60 by performing manipulations and the like using the mouse 18b and the like of the manipulation section 18 through a GUI (graphical user interface) while viewing a screen displayed on the display 20 in the manner described above. Also, a semi-automatic red eye correction processing method may be used with which manual processing through operator's manipulations, such as the designation of each red eye position, is performed in conjunction with automatic processing. The processing apparatus 14 is set so that it is possible to make a selection from among these processing forms as appropriate.

Next, in the catch light processing subsection 74 of the special image processing section 60, catch light appropriate to a photographing scene is generated in the region of each red eye corrected in the red eye correction processing subsection (pupil region of a living body image such as a human image or an animal image).

Here, in the catch light processing subsection 74, such appropriate catch light is generated by adding an appropriate catch light pattern selected in accordance with the photographing scene to the region corresponding to the red eye detected and corrected through the red eye correction processing, that is, the region of a pupil. When doing so, it is preferable that the position, size, and shape of the catch light pattern be selected so that the center of the catch light pattern is positioned at the center of the region of the eye (pupil region) and the catch light pattern is contained within the eye region.

Also, in the catch light processing subsection 74, it is judged as necessary whether the eye region (pupil region) in the image detected through the red eye correction processing contains pixels that are high in lightness, thereby detecting the presence or absence of catch light in the eye region and the degree of the catch light, that is, judging whether sufficient catch light exists in the eye region. Following this, if it is judged that insufficient catch light exists in the eye region, in the red-eye-corrected eye region (pupil region), the contrast of the catch light is increased or the color tint or shape of the catch light is changed in accordance with the photographing scene, thereby emphasizing the catch light in the pupil region. Alternatively, a catch light pattern having a shape and a color tint selected in accordance with the photographing scene is applied onto the insufficient catch light in the pupil region at a position selected in accordance with the photographing scene.

It should be noted here that in the red eye correction processing subsection 72, it is possible to perform the addition of the catch light pattern to the corrected eye region (pupil region of a living body image such as a human image) automatically or through operator's manipulations at the center of the eye region (pupil region) automatically detected in the red eye correction processing subsection 72, at the center of the eye region (pupil region) detected from an image displayed on the display 20 by the operator, or at a certain position of the eye region (pupil region) designated by the operator. Also, it is possible to perform the emphasizing of the catch light in the red-eye-corrected eye region (pupil region) or the addition of the catch light pattern to the eye region automatically or through operator's manipulations by, before or after the red eye correction, investigating an image contrast in the eye region (pupil region) automatically detected in the red eye correction processing subsection 72 and detecting a region having high lightness as catch light from the image displayed on the display 20 automatically or through operator's manipulations.

In this catch light detection, a judgment as to whether the pupil region-contains pixels that are high in lightness is made by judging whether the absolute value of the lightness in this pupil region satisfies a threshold value preset for the lightness value. Alternatively, this judgment is made based on the degree of a difference in lightness with respect to the average lightness of the pupil region in the image. Here, these lightness judgments may be made using only data of a G component and data of a B component among image data of the pupil region in the image. Also, the operator may judge whether the catch light emphasizing or the catch light pattern addition should be performed by confirming the image displayed on the monitor and checking whether catch light occurs in the pupil region of the image (human image, for instance) and whether the contrast and size of the catch light are sufficient.

It should be noted here that a method with which the catch light processing subsection 74 of the special image processing section 60 detects the catch light state, is not specifically limited and, aside from the method described above, it is also possible to use the methods disclosed in JP 11-308474 A and JP 2000-76427 A described above, JP 10-75347 A, and the like.

As a method of emphasizing the catch light, there is a method with which an image contrast in the pupil region containing a region judged as the catch light is increased. When doing so, it is preferable that a degree by which the contrast is increased is adjusted in accordance with the detected catch light state, image information, and photographing scene information. Also, the catch light may be more emphasized by changing the shape, color tint, and position of the catch light in accordance with the photographing scene information. In this case, it becomes possible to generate more appropriate catch light.

It should be noted here that the catch light emphasizing that can be performed in the catch light processing subsection 74 of the special image processing section 60 must be emphasizing corresponding to the photographing scene, although a technique itself for the emphasizing is not specifically limited so long as which emphasizing method is to be used is determined in advance. For instance, aside from the method described above, the methods disclosed in JP 11-308474 A and JP 2000-76427 A described above, JP 10-75347 A, and the like may be applied.

The catch light addition is achieved by selecting an appropriate catch light pattern from among multiple catch light patterns prepared in advance in accordance with the photographing scene and the photographing scene information and inserting the selected catch light pattern into the pupil region of the red-eye-corrected eye. When doing so, the catch light pattern is adjusted and inserted so that its center comes to the center of the pupil region of the eye, a designated position, or a catch light position and its size corresponds to the size of the eye region.

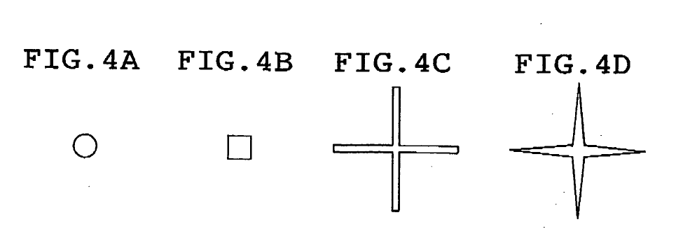

The shape of the catch light pattern is not specifically limited and it is possible to use various shapes as shown in FIG. 4A to FIG. 4D. For instance, as the catch light pattern, it is possible to use a circular pattern shown in FIG. 4A, a quadrilateral pattern shown in FIG. 4B, cross-shaped patterns shown in FIGS. 4C and 4D, and the like.

These catch light patterns may be selected automatically in the catch light processing subsection 74 in accordance with the photographing scene of the image and the image information or may be selected manually by the operator in accordance with the image.

Also, it is possible to add the catch light pattern at an arbitrary angle in accordance with the photographing scene of the image. Here, when it is possible to detect the direction of a light source generating the catch light or when it is possible to discriminate the light source direction from the image displayed on the display 20, it is preferable that the angle at which the catch light pattern is added be set in accordance with the light source direction.

Also, when the light source generating the catch light at the time of photographing (that is, a photographing light source) and/or the kind of a light source illuminating a photographing subject (light source of environmental light) are/is known, it is preferable that the shape, color tint, position, and angle of the catch light pattern, in particular, the color tint thereof be selected appropriately in accordance with the kind and form of the light source and information about the light source.

The color of the catch light or the color of the catch light pattern added is set as white in ordinary cases. However, when the kind of the light source of the environmental light at the time of photographing is known, for instance, it is preferable that the color tint of the catch light pattern be changed in accordance with the illumination in the scene where the image was photographed. For instance, if the kind of the light source at the time of photographing is known (fluorescent light or tungsten light, for instance), by changing the color tint of the catch light pattern in accordance with the kind of the light source, the catch light pattern is added in a more natural manner, which makes it possible to obtain a human image giving a more natural and lively impression.

When the catch light pattern is added, in particular, when no catch light is found in the eye region (pupil region), it is basically preferable that the catch light pattern be added so that its center comes to the center of the eye region (pupil region). When the direction of the light source (illumination) at the time of photographing is known, however, it is preferable that the catch light pattern be added in accordance with the direction of the light source (illumination). More specifically, when it is known that a human subject is illuminated from the upper-left side of an image, for instance, by giving the catch light pattern on the upper-left side of each pupil region in the image, the catch light pattern is added in a more natural manner, which makes it possible to obtain a human image giving a more natural and lively impression.

Also, it is preferable that the lightness of the catch light or the catch light pattern added have a gradation where the lightness becomes the maximum at the center and is gradually lowered radially from the center toward the edge. With such a gradation, it becomes possible to obtain a catch light pattern that is capable of expressing reflection on the surface of each eye (pupil) in a more natural manner, which makes it possible to obtain a human image giving a more natural and lively impression.

It should be noted here that the catch light pattern addition that can be performed in the catch light processing subsection 74 of the special image processing section 60 must use a catch light pattern appropriate to the photographing scene, although a technique itself for the addition is not specifically limited so long as an appropriate catch light pattern is prepared, selected, or set in advance. Therefore, aside from the method described above, the methods disclosed in JP 11-308474 A and JP 2000-76427 A described above, JP 10-75347 A, and the like may be applied.

In the special image processing section 60, the red eye correction processing in the red eye correction processing subsection 72 and the catch light generation in the catch light processing subsection 74 are basically performed in the manner described above.

Next, the condition setting section 64 that sets the kinds,; contents, and conditions of the ordinary image processing in the prescan processing section 54 and the fine scan processing section 58 will be described.

Referring again to FIG. 3, the condition setting section 64 includes a setup subsection 66, a key correction subsection 68, and a parameter integration subsection 70.

The setup subsection 66 of the condition setting section 64 is a subsection that determines a fine scan reading condition, the kinds, contents, and conditions of the ordinary image processing in the prescan processing section 54 and the fine scan processing section 58, and the like.

More specifically, at the time of printing with film processing, the setup subsection 66 creates a density histogram from prescan data and performs calculation of image characteristic amounts and other processing. Here, for instance, the calculated image characteristic amounts are predetermined % points of the frequency of the density histogram (such as an average density, a highlight (minimum density), and a shadow (maximum density)), an LATD (large area transmission density), and the maximum-value and minimum-value density of the histogram. Then, the setup subsection 66 sets a fine scan reading condition in the manner described above, determines image adjustments to be made in various kinds of image processing and their execution order in accordance with the density histogram, the image characteristic amounts, operator's designations, and the like, calculates conditions for the image processing and conditions for conversion in the display signal conversion section 56 and the printer signal conversion section 62, and supplies them to the parameter integration subsection 70.

It should be noted here that the contents and conditions of the special image processing (red eye correction processing and catch light generation processing) in the special image processing section 60 may also be set in the setup subsection 66 of the condition setting section 64.

The key correction subsection 68 is a subsection that calculates adjustment amounts for the image processing conditions in accordance with designations for a color adjustment, a density adjustment, a contrast (gradation) adjustment, and the like in the ordinary image processing inputted from the keyboard 18a and the mouse 18b of the manipulation system 18 and in accordance with designations for a correction position, a color adjustment, a density adjustment, a contrast (gradation) adjustment, and the like in the red eye correction processing also inputted from the keyboard 18a and the mouse 18b of the manipulation system 18. Then, the key correction subsection 68 supplies the calculated adjustment amounts to the parameter integration subsection 70.

The parameter integration subsection 70 receives the kinds and contents of the image processing, the image processing conditions, and the like calculated by the setup subsection 66, sets them at predetermined sites of the prescan processing section 54 and the fine scan processing section 58, and adjusts the set image processing conditions in accordance with the adjustment amounts calculated in the key correction subsection 68 and the like.

As described above, the image data subjected to the ordinary image processing in the prescan processing section 54 of the processing apparatus 14 is converted in the display signal conversion section 56 and the converted image data (processed prescan image data) is sent to the display 20. Also, the image data subjected to the ordinary image processing in the fine scan ordinary processing section 58 and optionally subjected to the special image processing in the special image processing section 60 is converted in the printer signal conversion section 62 and the converted image data (processed fine scan image data) is sent to the printer 16.

The printer 16 includes a printer (printing apparatus) that records latent images by exposing a photosensitive material (printing paper) in accordance with the supplied image data and a processor (developing apparatus) that performs predetermined processing on the exposed photosensitive material and outputs prints.

In the printer, for instance, after the photosensitive material is cut into a print length, a back print is first recorded. Next, three light beams for R exposure, G exposure, and B exposure are modulated in accordance with the image data outputted from the processing apparatus 14 and are deflected in the main scanning direction. Concurrently with this operation, the photosensitive material is transported in the auxiliary scanning direction orthogonal to the main scanning direction. As a result, the photosensitive material is two-dimensionally scan-exposed and latent images are recorded thereon. Following this, the photosensitive material is supplied to the processor. On receiving the photosensitive material, the processor performs predetermined wet development processing (coloring development, bleaching fixation, and rinsing, for instance) on the photosensitive material. Then, the processor dries the photosensitive material to thereby obtain prints, sorts the prints in units of one roll of film or the like, and accumulates the sorted prints.

Next, the image processing method according to the present invention will be described in more detail by explaining an operation of the photoprinter 10 shown in FIG. 1.

At the time of printout from the negative film F, the operator that performs the creation of prints of the film F mounts a carrier corresponding to the film F at a predetermined position of the scanner 12, sets the film F in the carrier, inputs the size of the prints to be created and various kinds of information set as image related information (preferably, photographing scene information and the like are inputted as necessary) or inputs required designations, selections, and settings, and designates the start of the print creation.

As a result, the f-number of the variable diaphragm 24 of the scanner 12 and the like are set in accordance with the reading condition for prescan. Following this, the carrier 30 transports the film F in the auxiliary scanning direction at a speed for prescan, the film F is slit-scanned at the predetermined reading position in the manner described above, projection light is imaged on the image sensor 34, and each image photographed on the film F is decomposed into R, G, and B and is photoelectrically read.

Also, at the time of the transport of the film by the carrier 30, a DX code and magnetic information recorded in the film F are read and are sent to the processing apparatus 14. Note that photographing scene information may be obtained from this magnetic information.

Among the information obtained through the operation described above, the information set as the image related information containing the photographing scene information is sent to the parameter integration subsection 70.

It should be noted here that the prescan and the fine scan are performed in units of one frame or are successively performed for all the frames or in units of a predetermined number of frames, for instance. Alternatively, the prescan is successively performed for all the frames or in units of a predetermined number of frames and the fine scan is performed in units of one frame or in units of multiple frames whose number is reduced from the case of the prescan, for instance. In the following description, for ease of explanation, a case where the prescan and the fine scan are both performed in units of one frame will be described as a representative example.

An output from the image sensor 34 is amplified by the amplifier 36, is converted into a digital signal by the A/D converter 38, is sent to the processing apparatus 14, is subjected to predetermined processing, such as offset correction, in the data processing section 46, is converted into digital image data by the Log converter 48, and is stored in the prescan memory 50.

After prescan data is stored in the prescan memory 50, the setup subsection 66 reads out this prescan data, performs the creation of a density histogram and the calculation of image characteristic amounts in the manner described above, sets a fine scan reading condition, such as the f-number of the variable diaphragm 24, from the results of these processing, and sends the set reading condition to the scanner 12.

The setup subsection 66 also selects ordinary image processing to be performed on each frame (image) in accordance with the density histogram and the image characteristic amounts as well as designations made by the operator, determines the order of the ordinary image processing, and calculates image processing conditions (signal conversion conditions) for the ordinary image processing. The set image processing conditions are sent to the parameter integration subsection 70 and are set at predetermined positions (hardware) of the prescan processing section 54 and the fine scan processing section 58.

When an inspection is to be conducted, after the image processing conditions are set in the prescan processing section 54, the prescan data is read out from the prescan memory 50, is subjected to the ordinary processing in accordance with the set image processing conditions in the prescan processing section 54, is supplied to the display signal conversion section 56, is converted into image data for displaying on the display 20, and is supplied to the display 20. As a result, a prescan image is displayed on the display 20 as a simulation image.

The operator confirms (inspects) the image displayed on the display 20 and performs a color adjustment, a density adjustment, a gradation adjustment, and other adjustments using an adjustment key set on the keyboard 18a and the like as necessary.

Then, adjustment signals are sent to the key correction subsection 68. The key correction subsection 68 calculates correction amounts for the image processing conditions in accordance with the adjustment signals and sends the correction amounts to the parameter integration subsection 70. The parameter integration subsection 70 corrects the image processing conditions set in the prescan processing section 54 and the fine scan processing section 58 in accordance with the sent correction amounts. Consequently, the image displayed on the display 20 also changes in accordance with the inputs made by the operator.

If the operator judges that the image displayed on the display 20 is appropriate (inspection OK), he/she issues a notification indicating that the displayed image is appropriate using the keyboard 18a or the like.

As a result, image processing conditions of the ordinary processing and a reading condition for fine scan are established, the f-number of the variable diaphragm 24 and the like in the scanner 12 are set to the established reading condition for the fine scan, the fine scan is started, and the carrier 30 transports the film F at a speed for the fine scan.

It should be noted here that when such an inspection is not to be conducted, at a point in time when the setting of the image processing conditions in the fine scan processing section 58 by the parameter integration subsection 70 is finished, the processing is established and the fine scan is started. Here, it is preferable that whether the inspection is to be performed be selectable as modes.

Fine scan is performed in the same manner as in the case of the prescan except that the reading condition is changed to the fine scan reading condition set in the manner described above. Then, an output signal of the image sensor 34 is processed in the amplifier 36 and the A/D converter 38, is processed in the data processing section 46 of the processing apparatus 14, is converted into fine scan data in the Log converter 48, and is sent to the fine scan memory 52.

After the fine scan data is sent to the fine scan memory 52, this fine scan data is read out by the fine scan processing section 58 and is subjected to the ordinary processing under the ordinary processing conditions established in the condition setting section 64.

The image data subjected to the ordinary processing in the fine scan processing section 58 is sent to the red eye correction processing subsection 72 of the special image processing section 60. As described above, in the red eye correction processing subsection 72, when an image has regions in which a red eye phenomenon occurs, each eye region (pupil region) in which an eye is colored in red is automatically detected, position information about the pupil region and the red eye region is acquired, and red eye correction is automatically performed. Even when no pupil region in which a red eye phenomenon occurs is detected in the image, the image data is sent to the red eye correction processing subsection 72, although no processing is performed on the image data in this case.

When an inspection is to be conducted, the output image data sent to the red eye correction processing subsection 72 of the special image processing section 60 is sent to the display signal conversion section 56 described above and is displayed as an image on the display 20. The operator confirms (inspects) the image displayed on the display 20 and performs semi-automatic red eye correction or manual red eye correction for each eye region in the image, in which a red eye phenomenon occurs but was not detected by the red eye correction processing subsection 72, through the GUI described above using the adjustment key set on the keyboard 18a, the mouse 18b, and the like while viewing the image displayed on the display 20 as necessary. When doing so, the image displayed on the display 20 also changes in accordance with inputs made by the operator. Then, if the operator judges that the red eye correction has been performed appropriately and the image displayed on the display 20 becomes appropriate (inspection OK), he/she issues a notification indicating that the red eye correction has been performed appropriately using the keyboard 18a and the like.

It should be noted here that when the inspection and the semi-automatic or manual red eye correction are not to be performed, at a point in time when the automatic red eye correction processing in the red eye correction processing subsection 72 is finished, the red eye correction processing is ended. It is preferable that whether the inspection is to be conducted be selectable as modes. In addition, it is also preferable that the full-automatic red eye correction, the semi-automatic red eye correction, the manual red eye correction, and the like are selectable as modes.

The image having undergone the red eye correction processing in the red eye correction processing subsection 72 is sent to the catch light processing subsection 74, in which catch light corresponding to the photographing scene of the image is generated in each eye region (pupil region) having undergone the red eye correction processing. When doing so, information about the photographing scene acquired from the film F in the scanner 12 is sent to the catch light processing subsection 74 of the special image processing section 60 from the parameter integration subsection 70. More specifically, the catch light generation by the catch light processing subsection 74 is performed by adding an appropriate catch light pattern corresponding to the photographing scene so that its center coincides with the pupil region in the image corrected in the red eye correction processing or by detecting the state of catch light in the red-eye-corrected pupil region and appropriately emphasizing the detected catch light in accordance with the photographing scene or adding a catch light pattern appropriate to the photographing scene to the detected catch light.

More specifically, when the catch light state in the red-eye-corrected pupil region is detected, it is judged whether the catch light is sufficient by judging whether the pupil region in the image detected through the red eye processing contains any pixels that are high in lightness as compared with their peripheral pixels. If it is judged that the catch light is insufficient, the catch light in the pupil region is emphasized by increasing the contrast of the catch light and changing the shape and color tint thereof or an appropriate catch light pattern is added to the pupil region in the image, as described above. These image processing may be performed automatically or may be performed manually. In the latter case, the operator performs manipulations through the GUI using the manipulation system 18 while viewing the display 20.

The image subjected to the predetermined processing in the catch light processing subsection 74 is sent to the printer signal conversion section 62, is converted into image data for outputting, and is outputted to the printer 16, which then creates a print where this image data has been reproduced.

The image processing method according to the present invention is not limited to the form where the image data for outputting is outputted to the printer 16. For instance, the image data may be recorded in a storage medium, such as a floppy (registered trademark) disk, an MO disk (magnetic recording disk), or a CD-R, as an image file.

The image processing method according to the present invention has been described in detail above, although the present invention is not limited to the embodiment described above and it is of course possible to make various modifications and changes without departing from the gist of the present invention.

1. An image processing method of performing predetermined processing on first image data of an first image obtained by optical photographing to obtain second image data for outputting, comprising:
detecting each pupil region, in which a red eye phenomenon occurs, in said first image based on said first image data;
performing red eye correction on detected pupil region through image processing based on said first image data; and
generating an appropriate catch light in said detected pupil region having undergone said red eye correction to obtain a second image having said appropriate catch light to a photographed scene of said first image.

2. The image processing method according to claim 1,
wherein said generating step of said appropriate catch light comprises a step of adding a catch light pattern to said detected pupil region having undergone said red eye correction.

3. The image processing method according to claim 2,
wherein said adding step of said catch light pattern comprises a step of changing at least one of a shape, a color tint and a position of a catch light pattern to be added in accordance with said photographed scene.

4. The image processing method according to claim 3,
wherein said changing step comprises a step of selecting one from among a plurality of catch light patterns, which have been prepared in advance and are different from each other in at least one of the shape, the color tint, and the position, in accordance with said photographed scene.

5. The image processing method according to claim 3,
wherein said color tint of said catch light pattern is changed in accordance with one of a color tint of a photographing light source of said first image and a kind of a light source illuminating a subject in said first image.

6. The image processing method according to claim 1,
wherein said generating step of said appropriate catch light comprises a step of detecting a state of a catch light in said detected pupil region and, when said detected catch light is insufficient, a step of emphasizing said detected catch light existing in said detected pupil region having undergone said red eye correction.

7. The image processing method according to claim 6,
wherein said detecting step of said state comprises a step of investigating presence and a degree of a catch light in said pupil region or absence of said catch light therein, in which said red eye phenomenon occurs, before said red eye correction is performed.

8. The image processing method according to claim 6,
wherein said detection of said state comprises a step of investigating presence and a degree of a catch light in said detected pupil region or absence of said catch light therein, in which said red eye phenomenon occurs, after said red eye correction is performed.

9. The image processing method according to claim 6,
wherein said emphasizing step of said detected catch light comprises a step of changing at least one of a shape, a color tint, and a position of said detected catch light to be emphasized in accordance with said photographed scene.

10. The image processing method according to claim 9,
wherein said changing step comprises a step of selecting one from among a plurality of catch lights, which have been prepared in advance and are different from each other in at least one of the shape, the color tint and the position, in accordance with said photographed scene.

11. The image processing method according to claim 9,
wherein said color tint of said detected catch light is changed in accordance with one of a color tint of a photographing light source of said first image and a kind of a light source illuminating a subject in said first image.
